(19) United States
(12) Patent Application Publication
(10) Pub. No.: US 2012/0194656 A1
(43) Pub. Date: Aug. 2, 2012

(54) SYSTEM AND METHOD FOR DISPLAYING MULTIPLE EXCLUSIVE VIDEO STREAMS ON ONE MONITOR

(75) Inventor: DAVID KILLIAN, LAKE WORTH, FL (US)

(73) Assignee: OPENPEAK, INC., BOCA RATON, FL (US)

(21) Appl. No.: 13/015,269

(22) Filed: Jan. 27, 2011

(51) Int. Cl. H04N 13/04; A63F 9/24; H04N 7/18

(52) U.S. Cl. 348/56; 348/61; 463/31; 348/E13.04

(57) ABSTRACT

A video display system and method that allows two different users to view different video streams on the same monitor without being able to see the other user's video stream. Frames of each video stream are rendered on the monitor. Each user views the monitor using a viewing device that allows the user to see his/her respective video stream and blocks the user from seeing frames associated with the other video stream.

### FIELD OF THE DISCLOSURE

The disclosure relates generally to media display systems, and more particularly to systems that display multiple video streams for different viewers where each video stream is rendered for a different viewer.

### BACKGROUND

Video and television systems are a mature technology. Recently, manufactures have begun to expand the functionality of such systems in order to provide viewers with a richer video experience. Recent advances include high definition and digital video display. More recently, advances in rendering speed and frame rate have allowed virtual three dimensional (3D) rendering of video in conjunction with corresponding eye wear or viewing devices. 3D technology has existed for some time in cinema in a passively viewed form, using either different colored filters for each eye, or using different polarizations for each eye, and where the viewed video is a composite, showing the video for both eyes at the same time. By using different filters for each eye, each eye perceives the video differently, allowing for the appearance of depth in the two dimensional display. There are problems with passive filtering, however. Using color filtering distorts the coloring of the video content. Polarization filtering can provide better suppression, and does not distort the color of the video, but requires the viewer to maintain head alignment, otherwise the suppression effect of the polarizing filters loses effectiveness as the viewer tilts their head from a horizontal alignment with the video.

More recently, in order to provide the appearance of depth, and leveraging the increased frame rendering or refresh rate of video monitors, active 3D viewing has been employed where each eye is alternately shuttered, and frames for each eye are rendered alternately in correspondence with the shuttering. The rendering and shuttering rate are performed at a rate which is not perceptibly significant, and which takes advantage of the natural persistence in perception when the human eye is exposed to an image.

However, even present active shuttering only renders one video stream. Anyone viewing the video, with or without the active shuttering eye wear, can only see the video that has been selected to be rendered. In some situations, however, it may be desirable for different people to see different video content displayed on the same monitor.

### SUMMARY

An embodiment includes a method for displaying multiple video streams on a single display where each video stream is intended to be seen by a different viewer. The method includes rendering frames of a first video stream in a first alternating time division of a video frame sequence on a video display monitor, and rendering frames of a second video stream in a second alternating time division of the video frame sequence on the video display monitor. The method further includes synchronizing a first actively shuttered viewing device with the first alternating time division of the video frame sequence such that a user of the first actively shuttered viewing device can only see the first video stream and not the second video stream, and synchronizing a second actively shuttered viewing device with the second alternating time division of the video frame sequence such that a user of the second actively shuttered viewing device can only see the second video stream and not the first video stream.

Another embodiment includes a video display system that includes a monitor operable to graphically render video frames, and a rendering engine operable to render frames of a first video stream and a second video stream on the monitor in alternating fashion, and provide a sync signal which changes state in correspondence with the alternating. The sync signal is provided to a first actively shuttered viewing device and a second actively shuttered viewing device, and the first actively shuttered viewing device uses the sync signal to allow a first viewer using the first actively shuttered viewing device to see the first video stream but not the second video stream. The second actively shuttered viewing device also uses the sync signal to allow a second viewer using the second actively shuttered viewing device to see the second video stream but not the first video stream.

Another embodiment includes a method for displaying video for two players of an interactive video game. The method includes generating a first video stream of a first game view for a first player using a first actively shuttered viewing device, and generating a second video stream of a second game view for a second player using a second actively shuttered viewing device. The method further includes alternately rendering frames of the first and second video streams on a monitor viewed by the first and second players through the first and second actively shuttered viewing devices, respectively. A sync signal is generated that alternately changes state in correspondence with rending the frames and is transmitted to each of the first and second actively shuttered viewing devices. The first and second actively shuttered viewing devices utilize the sync signal to control shuttering such that the first player can see the first video stream but not the second video stream and the second player can see the second video stream but not the first video stream.

Another embodiment provides a method for presenting multiple video streams on a monitor to be viewed exclusive of each other by different viewers. The method includes rendering a first video stream on the monitor using a first optical effect such that a first viewer using a first viewing device having left and right lenses both optically configured in correspondence with the first optical effect can see the first video stream. While rendering the first video stream on the monitor, the method further includes rendering a second video stream on the monitor using a second optical effect such that a second viewer using a second viewing device having left and right lenses both optically configured in correspondence with the second optical effect can see the second video stream. The first and second optical effect are complimentary such that the second video stream is substantially suppressed optically by the first viewing device, and the first video stream is substantially suppressed optically by the second viewing device.

In a further embodiment there is a video presentation system for displaying multiple exclusively viewable video streams on a single monitor. The system can include a first optical effect processor that applies a first optical effect to a first video stream. The first optical effect is such that a first viewer using a first viewing device having left and right lenses both optically configured in correspondence with the first optical effect can see the first video stream. The system also includes a second optical effect processor that applies a second optical effect to a second video stream. The second optical effect is such that a second viewer using a second viewing device having left and right lenses both optically configured in correspondence with the second optical effect can see the second video stream. The two video streams are combined by a stream combiner that combines the first and second video streams, including the first and second optical effects, into a composite signal. A rendering engine visually renders the composite signal on the monitor, including the first and second optical effects. The first and second optical effect are complimentary such that the second video stream is substantially suppressed optically by the first viewing device, and the first video stream is substantially suppressed optically by the second viewing device.

### BRIEF DESCRIPTION OF THE DRAWINGS

There are shown in the drawings, embodiments which are presently preferred, it being understood, however, that the invention is not limited to the precise arrangements and instrumentalities shown, nor that the presently preferred embodiments limit the scope of the subject matter disclosed herein to only those embodiments.

FIG. 1 shows a video rendering system and method of rendering video for multiple viewers where each viewer sees a different video displayed on the same monitor, in accordance with an embodiment;

FIG. 2 shows a video frame sequence diagram and method of rendering 3D video for multiple viewers where each viewer sees a different video displayed on the same monitor, in accordance with an embodiment;

FIG. 3 shows an active shuttering system circuit for eye wear for rendering multiple different video streams for different viewers, in accordance with an embodiment;

FIG. 4 shows a shuttering circuit for an active 3D eye wear system, in accordance with an embodiment;

FIG. 5 shows a system for synchronizing multiple active eye wear devices for rendering multiple video streams to multiple viewers at the same monitor, in accordance with an embodiment;

FIG. 6 shows a gaming system application for interactive multi-player games where each player views see their own game video and not the other player's game video, in accordance with an embodiment;

FIG. 7 shows a head tracking system for rendering video in apparent 3D without a need to alternately shutter each eye, in accordance with an embodiment;

FIG. 8 shows a view field of a camera used for rendering different video in apparent 3D for multiple viewers without a need to alternately shutter each eye, in accordance with an embodiment;

FIG. 9 illustrates the effect of head tracking in order to produce the appearance of 3D video, in accordance with an embodiment;

FIG. 10 shows a block diagram schematic of a rendering system employing head tracking in order to render apparent 3D video, in accordance with an embodiment;

FIG. 11 shows a block diagram schematic of a rendering system that combines two video streams that have each been processed to have a different optical effect, in accordance with an embodiment;

FIG. 12 shows a view diagram of a method and system for rendering and viewing combined video streams that have each been optically processed to have a different optical effect, in accordance with an embodiment; and

FIG. 13 shows a method and system for rendering and viewing video streams that have each been optically processed to have different optical effects and which are presented using active shuttering to produce a stereoscopic effect, in accordance with an embodiment.

### DETAILED DESCRIPTION OF THE DRAWINGS

While the specification concludes with claims defining features that are regarded as novel, it is believed that the claims will be better understood from a consideration of the description in conjunction with the drawings. As required, detailed embodiments are disclosed herein; however, it is to be understood that the disclosed embodiments are merely exemplary and can be embodied in various forms. Therefore, specific structural and functional details disclosed herein are not to be interpreted as limiting, but merely as a basis for the claims and as a representative basis for teaching one skilled in the art to variously employ the claims in virtually any appropriately detailed structure. Further, the terms and phrases used herein are not intended to be limiting but rather to provide an understandable description. Embodiments can include hardware implementations, software implementations, and implementations using both software and hardware.

Embodiments described herein allow different viewers to see different video streams or signals displayed on the same monitor in such a way that each viewer sees only his/her respective video stream, and is able to see it on the entire display area of the monitor instead of over a portion of the display area. Each viewer uses an actively shuttered viewing device to see his/her respective video rendering. Frames for each video stream are alternately rendered so that a frame from the first video stream is rendered, then a frame for the second video stream is rendered, alternating continuously. In conjunction with the alternate rendering, each actively shuttered viewing device comprises active lenses that can be optically opened and closed in conjunction with the alternate frame rendering so that the user sees only frames of their respective video stream but not frames of the other video stream.

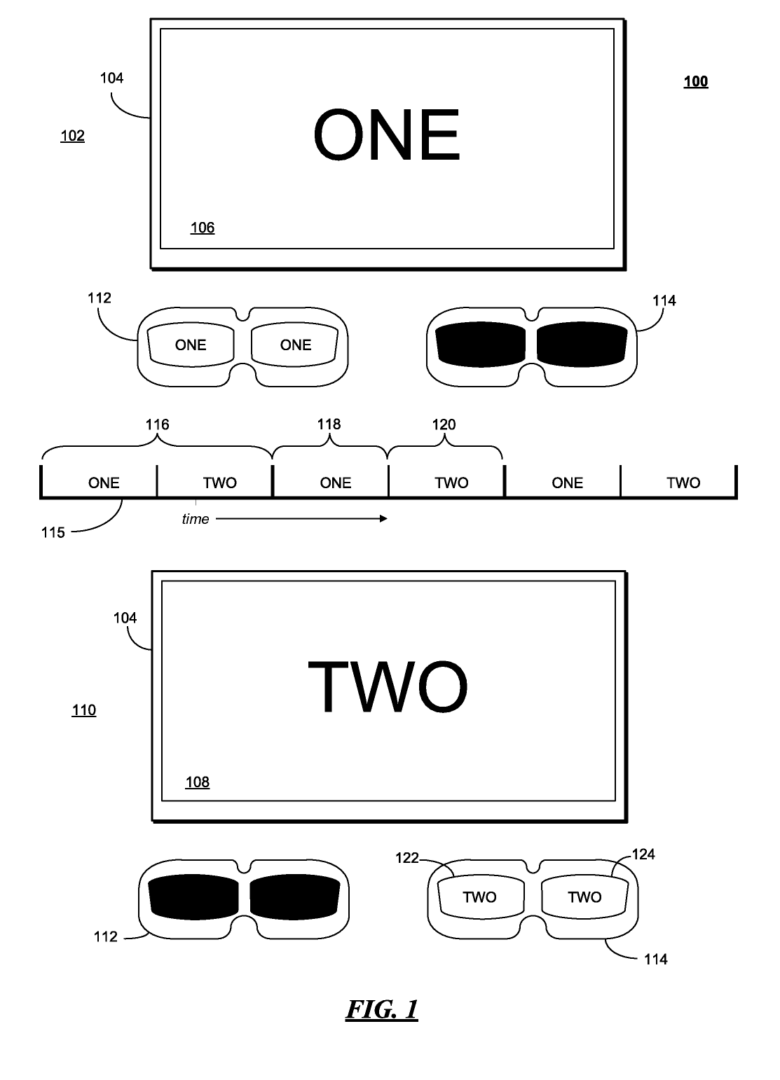

Referring to FIG. 1, there is shown a video rendering system 100 and method of rendering video for multiple viewers where each viewer sees a different video displayed on the same monitor, in accordance with an embodiment. Actively shuttered viewing devices are used by the different viewers to view their respective video stream. The actively shuttered viewing devices can take the form of glasses or other similar viewing gear. Each video stream is comprised of a series of frames, and consecutive frames of each video stream are alternatively displayed in synchronization with the shuttering of the actively shuttered viewing devices such that when a frame intended for a viewer is displayed, the lenses of the actively shuttered viewing device for that stream are open, meaning the lenses are transparent. The two video streams can be related, providing, for example, a different perspective of something, such as a virtual environment of multi-player video game, or they can be unrelated and provided by separate and unrelated sources. When a frame intended for a different viewer is displayed, the lenses of the actively shuttered viewing device for viewer or viewer for whom the frame is not intended are closed, meaning they are opaque, so that those viewers cannot see the rendered frame. The frame rates of the two video streams are suitably high enough so that the resulting perception is a continuous video stream for each viewer.

In the present drawing, a frame 106 of a first video stream 102 is presented on a video display monitor 104. As used in the present disclosure, the term “frame” refers to a visually renderable discrete portion or unit of video information, or the visually perceivable rendering of the portion or unit. Frames can be sequentially rendered at discrete time intervals to produce a time-dependent view of visually perceptible content. The term “video stream” as used herein refers to the sequence of frames that can be rendered to produce the time-dependent view of the visually perceptible content. The frame 106, upon being rendered on the monitor 104, shows the word “ONE,” merely used here as an example. As used here, the term “monitor” refers to the device or apparatus that includes the physical surface on which video information is visually rendered so that it can be seen, and can include circuitry and other elements for rendering the video information graphically, and can further include audio components for producing acoustic signals in conjunction with the rendered video information. A first actively shuttered viewing device 112, which is synchronized with the first video stream 102, has both lenses open and a user or viewer using the first actively shuttered viewing device 112 can see the image on the monitor through both lenses, as indicated by the appearance of the word “ONE” in each lens. A second actively shuttered viewing device 114, which is synchronized with a second video stream 110, has both lenses shut, indicated here by the dark lenses, so that the viewer using the second actively shuttered viewing device 114 cannot see the image of the first video stream. As used herein, the term “actively shuttered viewing device” refers to a device having a lens or lenses or viewing portal or openings through which a person looks, and wherein the lens or lenses are visually opened or closed. When a lens is “open” it is meant that there the lens does not obstruct the person's view when looking through the lens. When the lens is closed it is meant that the person cannot see through the lens. The monitor 104 can be any device capable of rendering frames of the video streams, and can include a television, computer monitor, or any other similar device capable of rendering video information.

The second video stream 110, in the present example, shows the word “TWO” as an example. The first actively shuttered viewing device 112, since it is synchronized with the first video stream 102, has its lenses closed (opaque) such that the viewer using it cannot see the monitor during the time that the frame of the second video stream 110 is rendered. The second actively shuttered viewing device 114, however, being synchronized with the second video stream 110, has its lenses open such that a viewing using that device can see the word “TWO” on the monitor, and indicated by the appearance of the word “TWO” in each lens of the second actively shuttered viewing device 114.

The actively shuttered viewing devices 112, 114 can use liquid crystal lenses that use a pane of liquid crystal material having transparent conductor layers on opposing sides of the lens for alternately activating and de-activating the liquid crystal material to cause the liquid crystal material to appear transparent or opaque. Each viewing device 112, 114 is synchronized to its corresponding video stream such that the viewer using the device 112, 114 can only see frames of the video stream with which the device 112, 114 is synchronized, and cannot see the frames of the other video stream. As a result, the viewers using devices 112, 114 see different video streams on the entire display of the monitor 104.

A frame sequence 115 illustrates a method for operating the system 100. Generally, there is a continuing sequence of frames of each video stream alternately being rendered into viewable form on the monitor 104. Each frame is rendered in one of two alternating time divisions 118, 120 of a frame cycle 116. Each alternating time division 118, 120 occupies substantially half of each frame cycle 116. Each successive frame of a given video stream can change from a previous frame so that motion and movement and other visual dynamics can be perceived by a viewer. A video stream, as used here, is defined as a received signal containing video information or data that is displayable. The signal can be received from any of a variety of signal sources, including local sources, such as a video media player or a video game system, as well as remote sources such as video content hosted on the Internet, video signals received from broadcast or other commercial sources such as community antenna television (CATV).

It is contemplated that the system of FIG. 1, in addition to displaying two different video streams to two different viewers, can display multiple phases of an image in each frame to produce a stereoscopic or three dimensional optical effect. In order for a viewer to perceive the three dimensional effect, the left and right lenses of the actively shuttered viewing devices can have polarizing optical filters through which the viewer views the display. For example, left lens 122 and right lens 124 can each have a polarizing filter, and these filters can be substantially orthogonal to each other and can correspond to the polarity of the portion of the displayed image intended for that eye. The polarizing filters suppress image components that are not aligned with the polarity of the filter. Thus, the polarizing filter of the left lens 122 suppresses image components that are polarized in correspondence with the right lens 124, and vice versa. The polarization of the different video streams is one type of optical effect that can be applied to the video streams. The optical effects applied to the different video streams are complimentary such that the second video stream is substantially suppressed optically by the first viewing device, and the first video stream is substantially suppressed optically by the second viewing device. As used herein, the term “optical effect” refers to the rendering of video content such that it can be optically distinguished from other video content having a different, or no optical effect that is rendered at the same time and in the same viewing area. By using a viewing device such as, for example, eyewear, that has an optical property corresponding to the optical effect, video content not treated with the corresponding optical effect is substantially optically suppressed and is not seen when looking through the viewing device with corresponding optical properties. Examples of optical effects include polarization and colorization, as is well known for rendering video content with a three dimensional effect.

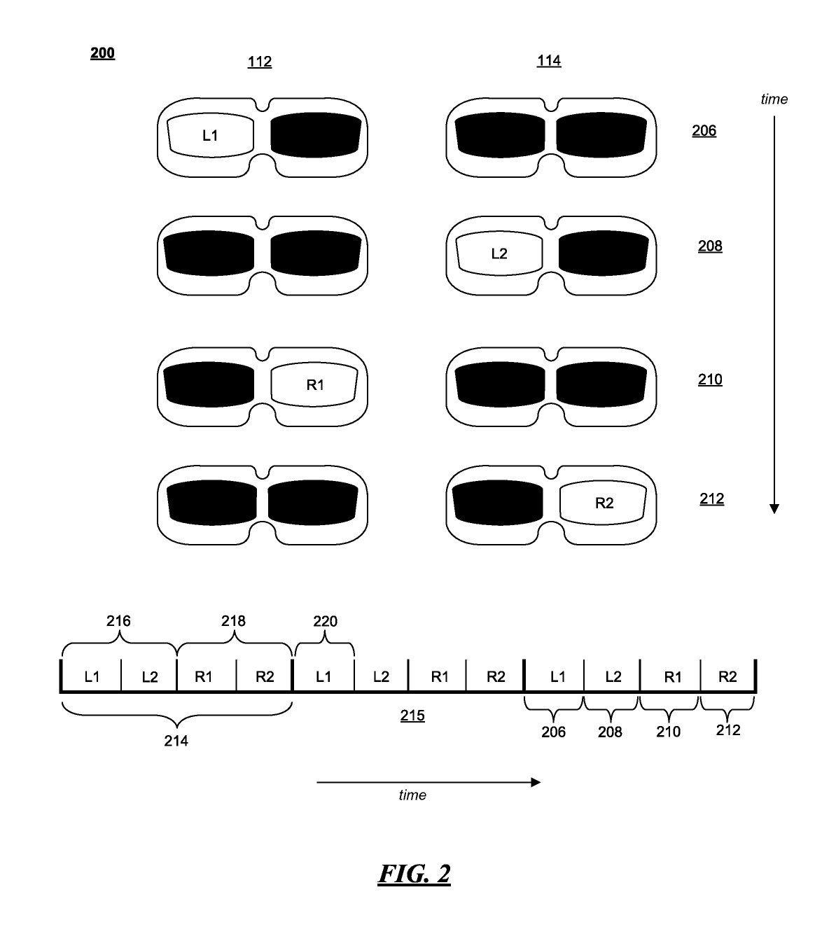

FIG. 2 shows a video frame sequence diagram 200 and method of rendering 3D video for multiple viewers where each viewer sees a different video stream displayed on the same monitor, in accordance with an embodiment. The diagram 200 shows an operating sequence for the first and second actively shuttered viewing devices 112, 114 over a single frame cycle, where the shuttering is used to show each video stream in a manner that is perceived as being in three dimensions. Each frame cycle contains one frame of video information for each video stream. Unlike in FIG. 1, where both lenses of the viewing devices 112, 114 are opened and closed together, where polarization can be used within a frame to achieve a stereoscopic view, the operation of FIG. 2 alternates opening and closing of the left and right lenses in synchronization with left and right subdivisions of frames, while still maintaining separation of video streams for each viewer.

In this example, for each viewing device 112, 114, each eye lens is alternately opened and closed once each frame cycle 214. A series of configurations 206, 208, 210, and 212 illustrate the process. In the first configuration 206, the left lens of the first viewer 112 is open, while the right lens is closed. Accordingly, a user would see a left sub-frame image as denoted by the “L1” in the left lens. Both lenses of the second viewing device 114 are closed at this time. In the next configuration 208, which occurs in a subsequent sub-frame time to configuration 206, the second viewing device 114 has its left lens open and its right lens closed, while both lenses of the first viewing device 112 are closed. Accordingly, a user of the second viewing device 114 would see an image with their left eye, as indicated by the “L2” in the left lens.

Configurations 210 and 212 then follow, opening the right lens for each viewing device 112, 114 in sequence. In configuration 210, the user of the first viewing device 112 sees the right sub-frame “R1,” while both lenses of the second viewing device 114 are closed. In configuration 212, the second viewing device 114 has its right lens open and its left lens closed so that the user sees the “R2” with the user's right eye. The configuration pattern can then repeat indefinitely, allowing each viewer to see a different video stream using the entire display of the monitor 104 in apparent stereoscopic presentation, without seeing the other video stream.

A method embodiment is illustrated in the frame sequence diagram 215. Over a given frame cycle 214, there is a left frame 216 and a right frame 218. Although shown here in a particular order, different orderings can be used, as will be appreciated by those skilled in the art. Each left frame 216 and right frame 218 is split into sub-frames 220 for each of the different video streams. Each frame cycle presents a left image and a right image for each of the two viewing devices 112, 114. The viewing devices, in synchronization, control their left and right lenses such that the user of the viewing devices 112, 114 sees the right and left sub-frames with only the corresponding eye, and when no sub-frames are displayed for the viewing device, both lenses are closed.

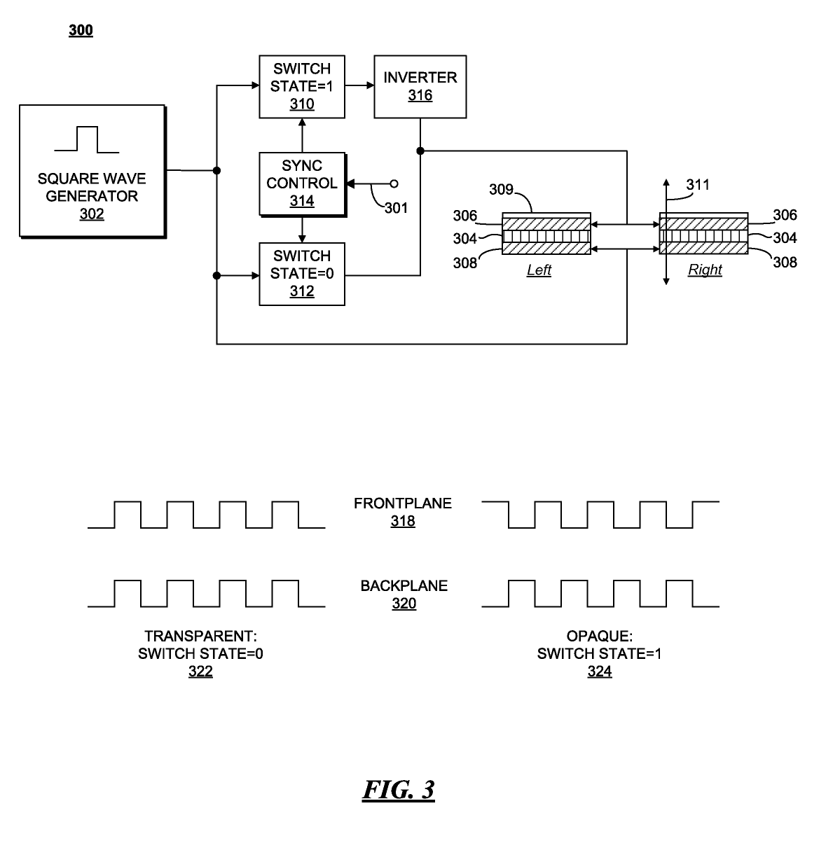

FIG. 3 shows an active shuttering system circuit 300 for an actively shuttered viewing device for rendering multiple different video streams for different viewers, in accordance with an embodiment. Each actively shuttered viewing device contains two lens assemblies, a “Left” assembly and a “Right” assembly, one for each eye. The lenses are shown here in a cut-away view through the various layers. Each lens assembly contains a layer of liquid crystal material 304, suitably contained between transparent wall members such as glass, and a pair of transparent electrode layers such as front plane 306 and backplane 308. The transparent electrode layers can be made of a transparent conductor material, such as indium tin oxide (ITO). Light passes through the lenses in the direction indicated by line 311. The electrodes are used to control a voltage differential between them, causing the liquid crystal material to change its optical properties. Furthermore, while the circuit and operation shown in FIG. 3 can be used for viewing two dimensional, non-stereoscopic video content, it is further contemplated that a polarizing lens 309 or overlay can be used over each lens to allow viewing of stereoscopic video content with an apparent three dimensional effect.

A common means for controlling the optical state of liquid crystal is to use a square wave generator 302, which generates a square wave signal. The square wave signal is applied to, for example, the backplane 308 of each lens assembly. The square wave signal is also fed to a pair of switches 310, 312, which have complementary switch states meaning that when one is closed the other is open, and vice versa. The switch state can be controlled by a sync control block 314. The sync control block 314 ensures that the switches 312, 314 operate in complementary states responsive to a sync signal 301. The square wave signal is applied to both the front plane 306 and the backplane 308, and the switches 310, 312 switch in or out an inverter 316, which inverts or delays the square wave signal so that the signal applied to the front plane 306 is inverted from that applied to the backplane 308. This technique creates a voltage differential and causes the liquid crystal material 304 to become opaque. The sync signal can be provided by a media controller and is timed in correspondence with the rendering of frames intended for the user of an actively shuttered viewing device incorporating or using the circuit of FIG. 3.

The sync signal 301 is timed so that when a rendered frame is to be seen by the user of the actively shuttered device, switch 312 is open and switch 310 is closed, causing the front plane 306 and backplane 308 to have no substantial voltage differential between them, causing the liquid crystal material to be transparent. When the rendered frame is not to be seen by the user of the actively shuttered viewing device, switch 310 is open and switch 312 is closed, causing the square wave signal applied to the front plane 306 to be inverted from that applied to the backplane 308, resulting in a voltage differential between the front plane 306 and the backplane 308, which causes the liquid crystal material to be opaque. These states are illustrated as a backplane signal 320 and the front plane signal 318. When the switches are at switch state “0” 322, switch 312 is open and switch 310 is closed, so the front plane signal 318 and backplane signal 320 are the same. At switch state “1” 324 responsive to the sync signal 301 changing state, switch 310 is open and switch 312 is closed, causing the square wave signal to pass through inverter 316 so that the front plane signal 318 is inverted in relation to backplane signal 320.

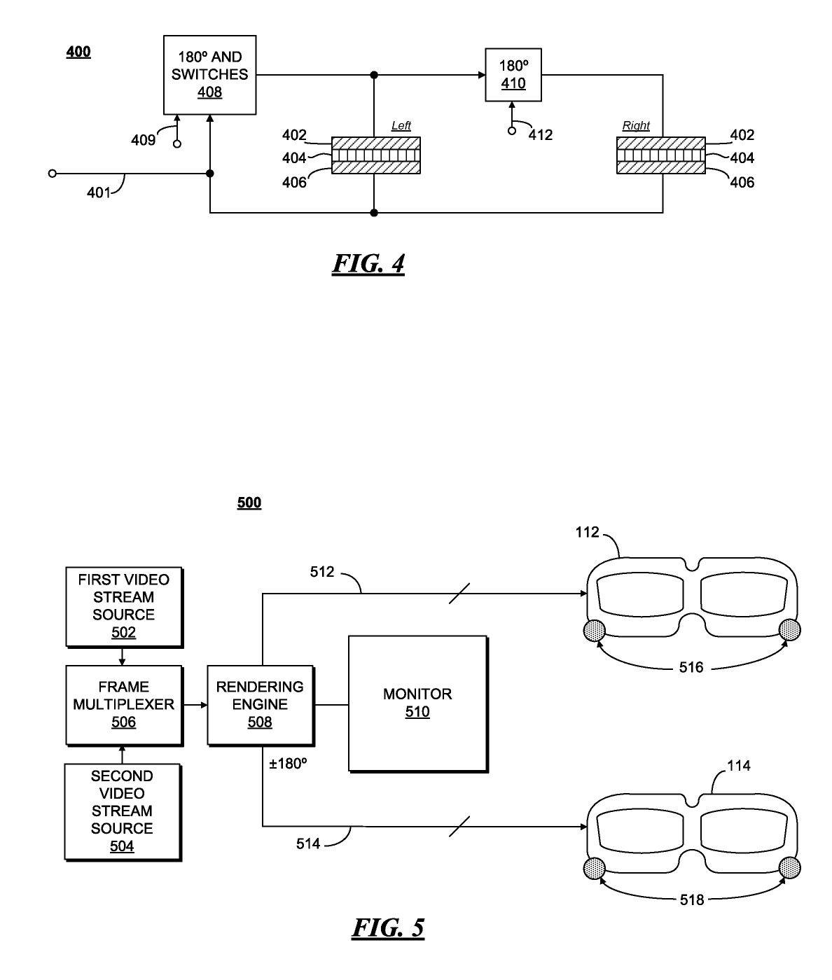

FIG. 4 shows a shuttering circuit 400 for an active 3D eye wear system, in accordance with an embodiment. The present circuit is similar to that of FIG. 3, except that instead of always shutting both lenses either open or closed, the present circuit allows the left and right lenses to be opened while the other lens remains closed, as illustrated in FIG. 2. Thus, the present circuit facilitates active stereoscopic vision for apparent three dimensional viewing, as well as facilitating the masking of frames for content not intended for the user of an actively shuttered viewing device utilizing the present circuit. A square wave signal 401 is provided to the backplane 406 of the left and right lenses. To achieve shuttering and masking (where both lenses are closed/opaque), the square wave is selectively inverted by switches and inverter block 408, which contains substantially similar circuit elements as switches 310, 312, and inverter 316 of FIG. 3. Likewise a sync signal 409 is provided to enable or disable the inversion of the square wave signal 401. To accomplish alternate shuttering of the left and right lenses, a second inverter 410 can be used to further selectively invert the square wave signal applied to the front plane 402 of the left lens, responsive to a mask signal 412. When the sync signal is not asserted, the square wave signal fed to the front plane 402 of the left lens is in phase with the signal fed to the backplanes 406. If the mask signal 412 is similarly not asserted, then the second inverter 410 is bypassed and the front plane 402 of the right lens is also in phase with the square wave signal fed to the backplanes 406, and both lenses are open/transparent.

To close both lenses, sync signal 409 is asserted while mask signal 412 remains de-asserted, resulting in an inverted square wave signal to be fed to both front planes 402. To close the left lens, both the sync signal 409 and the mask signal 412 are asserted, causing an inverted square wave to be applied to the front plane 402 of the left lens, while the square wave signal fed to the front plane 402 of the right lens is delayed 360 degrees so that it is in phase with the square wave signal fed to the backplanes 406, resulting in the right lens being open/transparent. To close the right lens, the sync signal 409 is de-asserted and the mask signal 412 is asserted, causing the square wave signal applied to the front plane 402 of the right lens to be 180 degrees out of phase with the signal fed to the backplanes 406 and the front plane 402 of the left lens.

FIG. 5 shows a system 500 for synchronizing multiple actively shuttered viewing devices 112, 114 for rendering multiple video streams to multiple viewers at the same monitor, in accordance with an embodiment. The system displays video information from a first video stream source 502 to a user of a first actively shuttered viewing device 112, and video information from a second video stream source 504 to the user of a second actively shuttered viewing device 114. The first and second video stream sources 502, 504 can be derived from a common device, such as a video game console, a set top box, etc. or they be from unrelated sources such as from a cable television source and a video media player source, for example. Each of the video stream sources 502, 504 provide continuous video content that can be framed. A frame multiplexer 506 alternates between frames of the first video stream source 502 and the second video stream source 504, and feeds the frames to a rendering engine 508. The rendering engine 508 renders each frame on a monitor 510 so that it can be seen by the intended viewer. The frame multiplexer 506 and rendering engine 508 can be integrated into a display device that includes the monitor 510, although such an arrangement is not necessary.

Signals 512 corresponding to the first video stream source 502 can be transmitted to the first actively shuttered viewing device 112, and can include a sync signal, a mask signal, and audio signals that can be played over speakers 516 associated with the first actively shuttered viewing device 112. When the video content is not active stereoscopic, which requires the mask signal, no mask signal needs to be present.

Likewise, signals 514 can be transmitted to the second actively shuttered viewing device 114 and include a sync and mask signal that are appropriately phase shifted relative to the sync and mask signal of signals 512, as well as audio signals to be played over speakers 518 associated with the second actively shuttered viewing device 114. The signals 512, 514 can be transmitted through wires or by wireless means. The sync and mask signals are changed by the rendering engine 508 in correspondence with the rendering of each frame.

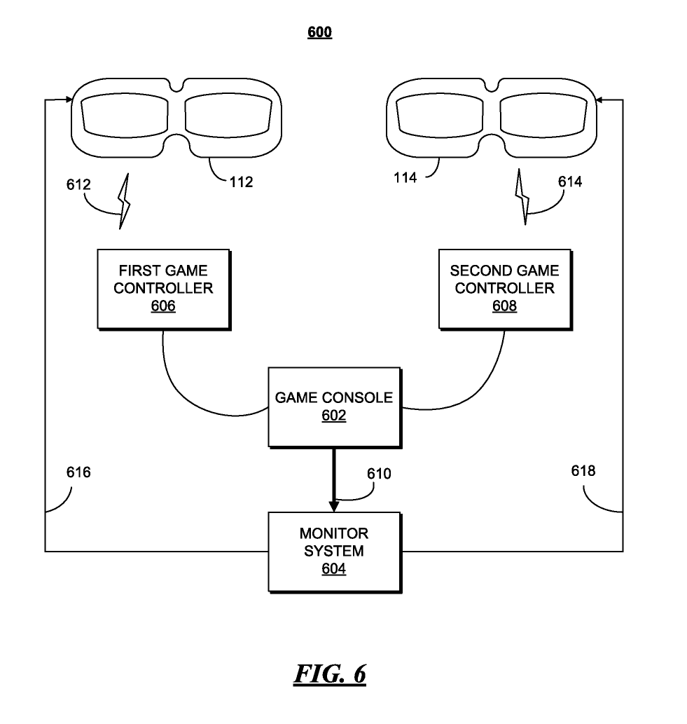

FIG. 6 shows a gaming system application 600 for interactive multi-player games where each player views his/her own game video, and not the other player's game video, in accordance with an embodiment. Multi-player games are popular and, conventionally, the screen area of the monitor 604 is divided in half (or in quadrants for 3-4 players) and each player's game view is rendered in one of the screen divisions. However, by using actively shuttered viewing devices 112, 114, two players can see their game view in the full display area of the monitor 604 without seeing the other player's game view.

A game system such as a game console 602 executes a game program stored on machine readable storage media, such as a disk, drive or memory cartridge, as is known. The game console 602 generates one or more video streams 610 portraying game play for an interactive video game. The video stream 610 is transmitted to the monitor system 604 so that it can be rendered on a display of the monitor system 604. Furthermore, the game console 602 can be used for multi-player game play and can produce a separate video stream for each player. A first player can use the first actively shuttered viewing device 112, while a second player can use the second actively shuttered viewing device 114. Accordingly, the game console 602 generates first and second video streams 610 which, when rendered by the monitor system 604, portray game play for the first and second players and provide each player with a full view of their respective game play. Frames of the two video streams 610 are alternately rendered using methods substantially similar to that illustrated in FIGS. 1 and 2 so that each player sees their game play on the full display area of the monitor system 604. Although the game play (or other content) is described here as taking up the entire display area, it is understood that the displayed content (one or multiple video streams 610) may utilize less-than-whole portions of the display area.

To facilitate synchronization of each of the viewing devices 112, 114, each viewing device 112, 114 can be associated with a game controller, such as first game controller 606 and second game controller 608. The association can be made via a link 612, 614, respectively, which can be a wired or wireless link. The links 612, 614 can simply indicate on which phase of the sync signal the respective viewing device 112, 114 is to trigger shuttering. For example, the monitor system 604 can include a frame multiplexer and rendering engine (similar to that shown in FIG. 5), which receive the video stream information for each video stream 610 from the game console 602. The video streams 610 can be provided by separate connections to the monitor system 604, or they can be multiplexed over a single connection to the monitor system 604. Accordingly, the monitor system 604 provides sync signals 616, 618 to the first and second viewing devices 112, 114, respectively. Since each viewing device 112, 114 can determine which game view it is associated with via the links 612, 614 with the controllers 606, 608, the sync signal can simply be a binary signal that transitions from a logic level “0” to a logic level “1” and back in correspondence with rendering frames for the first video stream and then the second video stream. The first viewing device 112 can time its shuttering to the logic level “0” state and the second viewing device 114 can time its shuttering to the logic level “1” state of the sync signal. In an alternative embodiment, rather than being associated with the game controllers 606, 608, each viewing device 112, 114 can have a switch to set the viewing device 112, 114 to either the first player or the second player. The setting of the switch can then dictate on which state of the sync signal to time shuttering of the viewing device 112, 114.

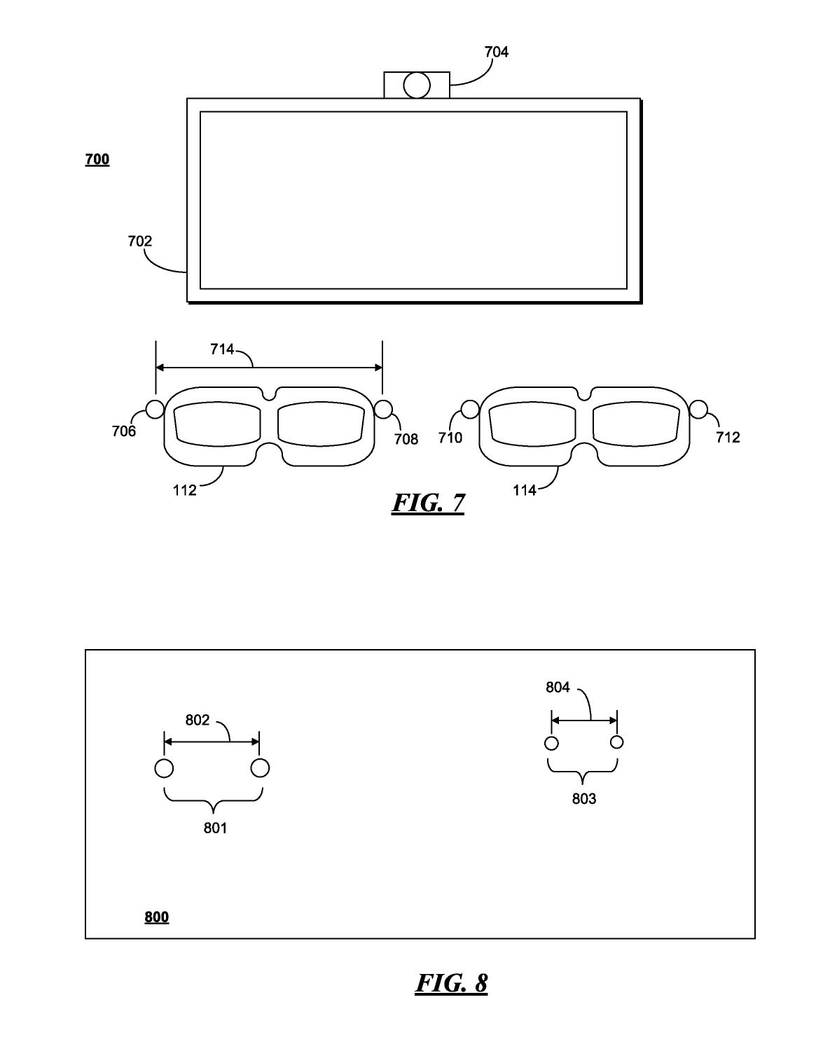

FIG. 7 shows a head tracking system 700 for rendering video in apparent 3D without a need to alternately shutter each eye, in accordance with an embodiment. The present embodiment presents an alternative for three dimensional viewing by windowing the viewers view. As the viewer moves, their movement is tracked by the system 700 and the rendered image is adjusted in response to their movement and position in front of the monitor 702, creating an effect where the monitor 702 appears to function as a virtual window into a larger virtual space. Just as when a person looks through a real window and sees different things through the window upon moving their viewing position, position tracking can be used for a virtual view to adjust the virtual view to simulate the same effect. By using the active shuttering techniques taught herein, however, two people can both view different virtual three dimensional views. The monitor 702 renders video frames alternatively for two different actively shuttered viewing devices 112, 114. Each viewing device 112, 114 comprises optical markers. First actively shuttered viewing device 112 has optical markers 706, 708 and the second actively shuttered viewing device 114 has optical markers 710 and 712. The optical markers 706, 708, 710, 712 can be detected by a camera 704 when they are in a field of view of the camera 704. The optical markers 706, 708, 710, 712 of each viewing device 112, 114 are at a known distance apart, and have a particular optical property to identify each of the viewing devices 112, 114. For example, each viewing device 112, 114 can have different colored optical markers 706, 708, 710, 712. The optical markers 706, 708, 710, 712 can be reflective, reflecting a particular color, or they can be emissive, such as a light emitting diode (LED), emitting a particular wavelength or pattern so that the system can identify each viewing device 112, 114.

FIG. 8 shows a view field 800 of the camera 704 used for rendering different video in apparent 3D for multiple viewers without a need to alternately shutter each eye, in accordance with an embodiment. The camera 704 can be sensitive to a particular wavelength or optical property of optical markers. A first pair of optical markers 801 and a second pair of optical markers 803 appear in the field of view of the camera. The horizontal and vertical positions of the optical markers 801, 803 in the field of view can be determined, indicating the direction and angle of view of the user. Furthermore, the apparent distance 802, 804 between the optical markers in each pair of optical markers 801, 803 indicates how far away from the camera 704 the viewing device on which the respective optical markers 801, 803 are mounted is from the camera 704, allowing further determination of the viewer's angle of view of the monitor 702. The determination of the angle of view allows the system 700 to adjust the virtual view presented to each viewer, in conjunction with the active shuttering techniques describe herein.

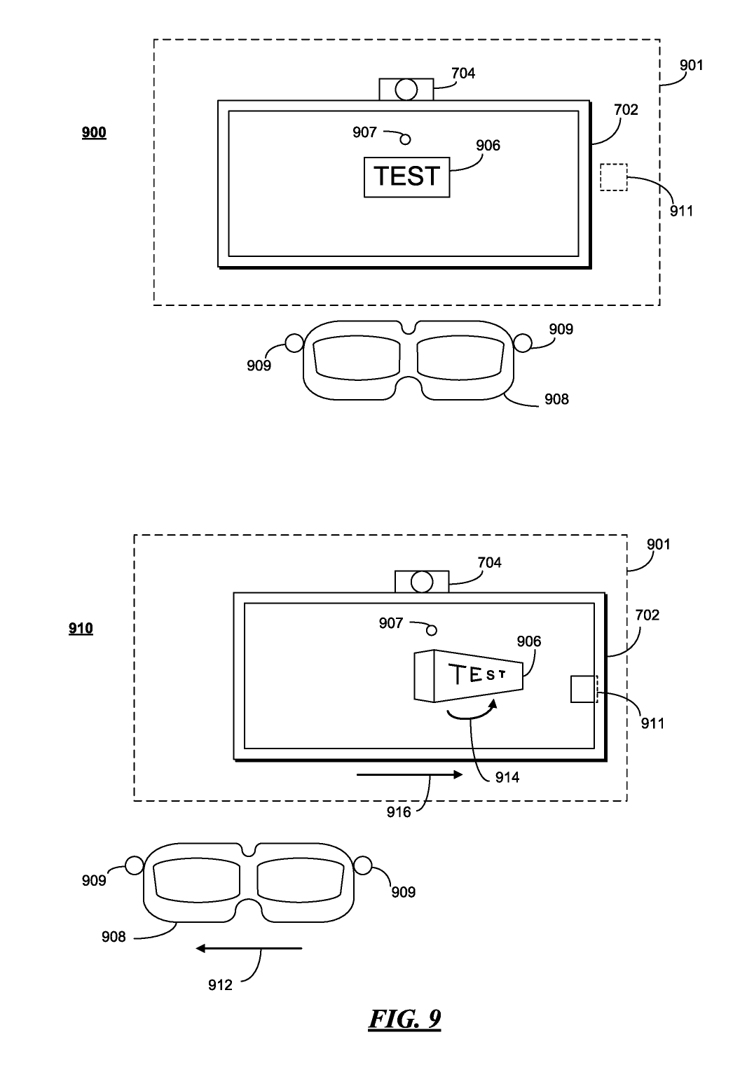

FIG. 9 illustrates the effect of head tracking in order to produce the appearance of virtual 3D video, in accordance with an embodiment. A first view 900 and a second view 910 are shown. Both the first view 900 and second view 910 portray a view into a three dimensional virtual space represented by background area 901. In the first view 900, an actively shuttered viewing device 908 having optical markers 909 is in a first position relative to a camera 704, which is used to visually detect optical markers in a field of view of the camera 704, which includes an area in front of the monitor 702. Visual information from the camera 704 is processed by the system to determine the angle of the viewing device to the monitor 702 so that the image presented on the monitor 702 can be adjusted correspondingly to provide a real time, virtual three dimensional view on the monitor 702. While the viewing device 908 is in the first position in first view 900, a first object 906 and a second object 907 may be rendered visually on the monitor 702. A third object 911 is in the virtual space 901, but not in view in the first view 901. In the present example, first object 906 is meant to appear in the foreground of the rendered view, while second object 907 and third object 911 are meant to appear farther away in the background of the view.

Accordingly, when the viewing device 908 is moved to a different position in second view 910, where the viewing device 908 has moved to the left as indicated by arrow 912, the camera 704 is used to detect the change of position by tracking movement of the optical markers 909 in the field of view of the camera 704. The first view 900 may be adjusted as the viewing device 908 is moved to provide the appearance of a virtual three dimensional view. Accordingly, the monitor 702 is treated as a window into virtual space 901, and is moved to the right relative to the virtual space 901 as indicated by arrow 916. Furthermore, first object 906 is moved farther to the right than second object 907 since first object 906 is in the foreground. Additionally, the perspective of first object 906 changes to provide a partial side view or isometric view of first object 906. The effect is similar to a slight rotation of the first object 906 as indicated by arrow 914. Third object 911, which was not viewable in first view 900 has become partially viewable in second view 910 because of the change of perspective.

By using active shuttering techniques as shown in FIGS. 1 and 2, two people can use a head tracking system as shown in FIG. 9 to see different virtual views on the same monitor with a full screen view, meaning their view is rendered over substantially the entire viewing area of the monitor. Each user could see unrelated content, or the system could be used for interactive media, such as video games. For example, each player using a head tracking system employing active shuttering can participate in a virtual tennis match. Each player sees the virtual tennis court from their respective perspective, seeing the other player's avatar across a virtual tennis court. As a virtual tennis ball is volleyed back and forth, the player can move and use controllers with motion sensing, as is now common in game systems, to “swing” a virtual tennis racket and hit the virtual tennis ball. As the players move, their perspective of the virtual tennis court can be adjusted accordingly.

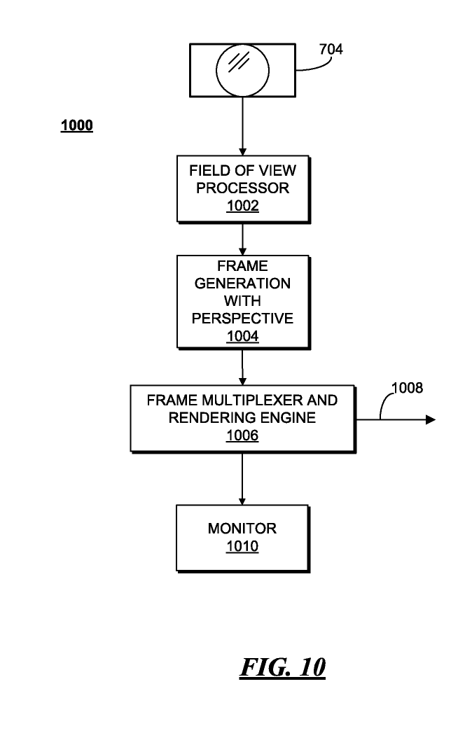

FIG. 10 shows a block diagram schematic of a rendering system 1000 employing head tracking in order to render apparent 3D video, in accordance with an embodiment of the invention. A camera 704 allows for visual detection of two actively shuttered viewing devices in a field of view of the camera. Each of the viewing devices is detected using optical markers on the viewing devices. By determining the distance from the camera 704 and the horizontal and vertical position in the field of view of the camera 704, the system 1000 can determine the viewing angle of each of the viewing devices using a field of view processor 1002. The position and distance information can be used by a frame generator to produce video frames for each viewing device with the appropriate perspective of a virtual scene 1004. A video stream results from the process of continuously generating frames for each viewing device. The frames for each video stream are provided to a multiplexer and rendering engine 1006, which alternates rendering frames from each video stream. The engine 1006 also provides a sync signal 1008 to allow shuttering of the viewing devices in correspondence with their respective video streams so that the user of each device sees his/her own virtual view in full screen view but does not see the other user's view when the frames are alternately rendered on a monitor 1010.

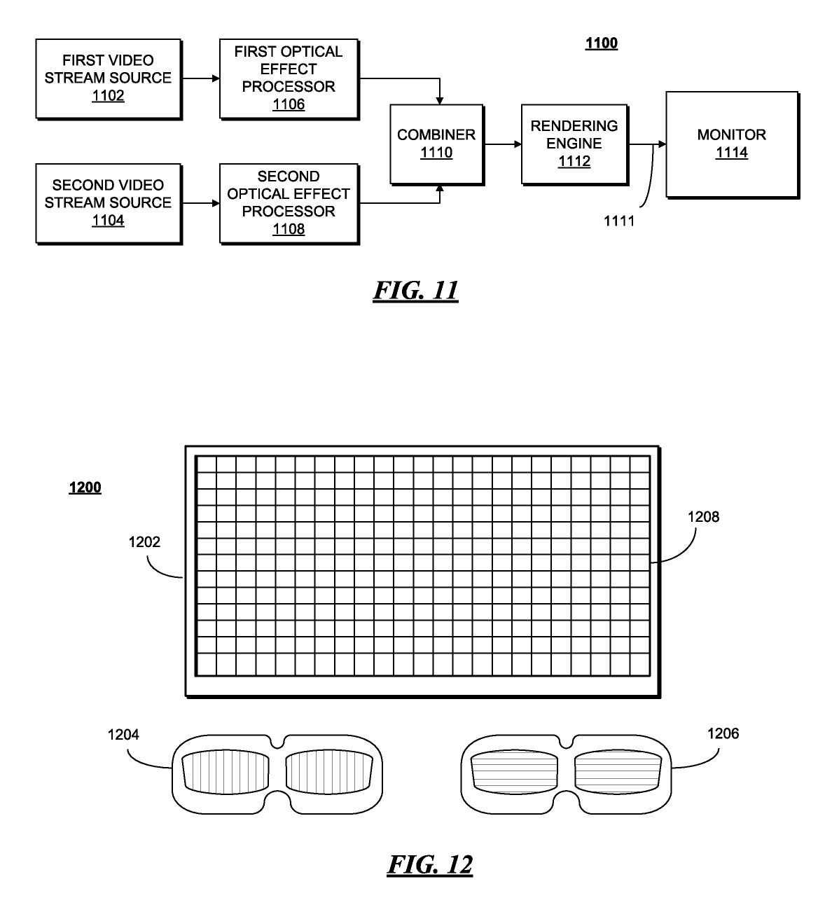

FIG. 11 shows a block diagram schematic of a rendering system 1100 that combines two video streams that have each been processed to have a different optical effect. Embodiments consistent with the present example allow different video streams to be rendered on the entire monitor to be visually perceived at the same time by different viewers—where viewers of one vide stream cannot see the other video stream—using only passive optical techniques. A first video stream source 1102 and a second video stream source 1104 produce or provide a first video stream signal and a second video stream signal, respectively. The first video stream source 1102 provides the first video stream signal to a first optical effect processor 1106, and the second video stream source 1104 provides the second video stream signal to a second optical effect processor 1108. The first and second optical effect processors 1106, 1108 modify their respective video stream signals so that each video stream signal has an optical effect when rendered. Examples of optical effects include optical polarization and colorization. The optical effects applied to the first and second video streams can allow suppression of the other video stream when viewed with a viewing device having a corresponding optical effect. The optically processed first and second video streams are combined by a combiner 1110 to produce a composite signal 1111, which is provided to a rendering engine 1112 so that the composite signal 1111 can be rendered on a monitor 1114, including the optical effects.

FIG. 12 shows a view diagram of a method and system 1200 for rendering and viewing combined video streams that have each been optically processed to have a different optical effect. A monitor 1202 visually displays a composite video stream of two video streams, a first one showing vertical lines and a second one showing horizontal lines, which, to a person not using an appropriate viewing device, would like a mesh 1208. A first viewing device 1204 has left and right lenses that both have an optical property or effect corresponding to the optical effect applied to first video stream. Accordingly, a viewer or user using the first viewing device 1204 looking at the monitor 1202 will only see the vertical lines. Similarly, a second viewing device 1206 has left and right lenses that both have an optical property or effect corresponding to the optical effect applied to the second video stream, and upon viewing the monitor 1202 will only see the horizontal lines. The mesh 1208 example used here is merely to present a simple example, but ordinary television, movie, video game, and other video media can be used equivalently.

It is contemplated that when the optical effect used is polarization, the monitor may alternate between showing a frame of the first video stream using a first polarization, and showing a frame of the second video stream using a second polarization. The effect is similar to active shuttering techniques, but active shuttering is not required because the viewing devices block out the frames of the other video stream. This allows the monitor to switch from one polarization to an orthogonal polarization when switching from rendering a frame of the first video stream to rendering a frame of the second video stream so that the monitor only has to display in one polarization orientation at a time. In such an embodiment, the combiner 1110 can be a multiplexer that alternates between frames of the two video streams.

In another embodiment, it is contemplated that the monitor 1202 can be a projection screen where each of the video streams is projected using a different projector onto the same screen and where each projector uses a different polarization that is orthogonal to the other projector. In such an embodiment, the combiner 1110 can be an optical combiner, which combines the two projections into one projection. Alternatively, the screen can act as the combiner 1110 when both video streams, and their respective optical effects, are projected onto the screen, in which case the rendering engine 1112 is not applicable and the combiner 1110 and monitor 1114 are essentially the same entity.

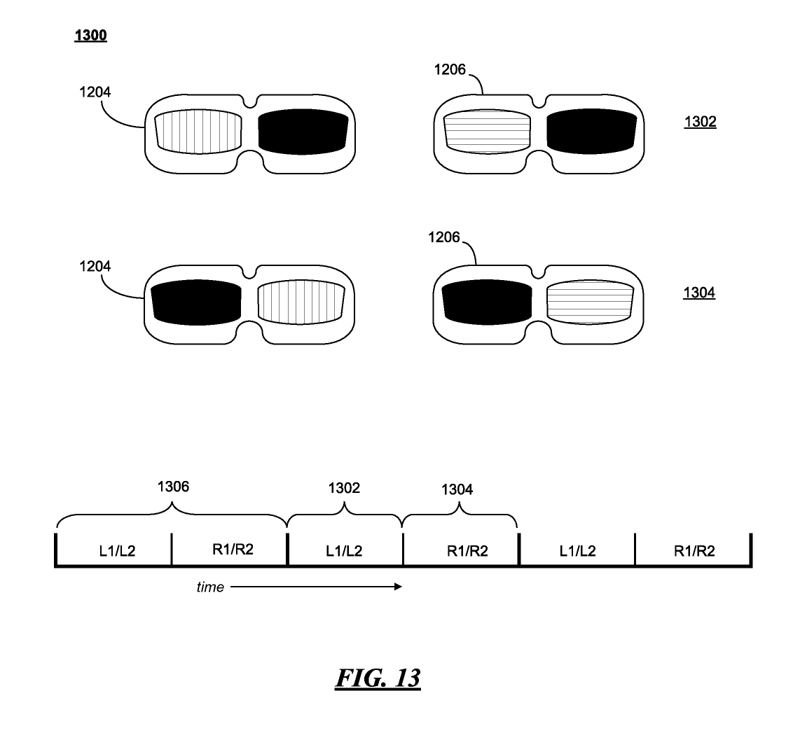

FIG. 13 shows a method and system 1300 for rendering and viewing video streams that have each been optically processed to have different optical effects and which are presented using active shuttering to produce a stereoscopic effect. A first viewing device 1204 and a second viewing device 1206 are both actively shuttered viewing devices having left and right lenses which both have the same optical effect. So, for example, viewing device 1204 can have both lenses with vertical polarization, and viewing device 1206 can have both lenses with horizontal polarization. Furthermore, each lens of the first and second viewing devices 1204, 1206 is actively shuttered such that each viewing device has one lens open and one lens closed when in use. In scenario 1302, both viewing devices have their left lens open and right lens closed. In scenario 1304, both viewing devices 1204, 1206 have the left lens closed and right lens open. In embodiments consistent with the present example, the optical effect allows optical separation of the video streams, while the active shuttering allows for stereoscopic effect. Accordingly, over a frame cycle 1306, there is a left sub-frame and a right sub-frame. The left sub-frame contains a left frame L1 for the first video stream and a left sub-frame L2 for the second video stream. The right sub-frame contains a right frame R1 for the first video stream and a right sub-frame R2 for the second video stream. Other arrangements will occur to those skilled in the art, such as having a sub-frame contain a left sub-frame for one video stream and a right sub-frame for the second video stream. A sync signal is provided to the viewing devices 1204, 1206 to time shuttering in correspondence with the changing of frames.

This description can be embodied in other forms without departing from the spirit or essential attributes thereof. Accordingly, reference should be made to the following claims, rather than to the foregoing specification, as indicating the scope of the invention.

What is claimed is:

1. A method for displaying multiple video streams on a single display where each video stream is intended to be seen by a different viewer, comprising:
rendering frames of a first video stream in a first alternating time division of a video frame sequence on a video display monitor;
rendering frames of a second video stream in a second alternating time division of the video frame sequence on the video display monitor;
synchronizing a first actively shuttered viewing device with the first alternating time division of the video frame sequence such that a user of the first actively shuttered viewing device only sees the first video stream but not the second video stream; and
synchronizing a second actively shuttered viewing device with the second alternating time division of the video frame sequence such that a user of the second actively shuttered viewing device only sees the second video stream but not the first video stream.

2. The method of claim 1, further comprising:
optically tracking at least one of the first or second actively shuttered viewing devices relative to the display; and
graphically modifying the frames of the video stream corresponding to the tracked viewing device to create a depth effect.

3. The method of claim 1, wherein rendering the frames of the first video stream and second video stream comprise rendering frames of an interactive video game where the first video stream is a first game player's view of the interactive video game and the second video stream is a second game player's view of the interactive video stream.

4. The method of claim 3, wherein the first actively shuttered viewing device is associated with a first game controller of a game system facilitating the interactive video game, the second actively shuttered viewing device is associated with a second game controller of the game system, synchronizing the first actively shuttered viewing device with the first alternating time division is based on the association between the first actively shuttered viewing device and the first game controller and synchronizing the second actively shuttered viewing device with the second alternating time division is based on the association between the second actively shuttered viewing device and the second game controller.

5. The method of claim 1, wherein synchronizing the first and second actively shuttered viewing devices is performed by a wireless link to the first and second actively shuttered viewing devices.

6. The method of claim 1, wherein rendering the frames of the first video stream and the second video streams comprises rendering a left sub-frame and a right-sub-frame for each of the first and second video streams, wherein the left sub-frames are each rendered for a left time sub-division and the right sub-frames are each rendered in a right time-subdivision of the first and second time divisions, respectively; and
wherein synchronizing the first and second actively shuttered viewing devices comprises alternately shuttering a left side and a right side of each of the actively shuttered viewing devices in correspondence with the left and right time-subdivisions for each of the first and second time subdivisions, thereby producing a three dimensional effect for the first and second video streams when viewed through the first and second actively shuttered devices, respectively.

7. The method of claim 1, wherein rendering frames of the first and second video streams comprises rendering the frames with an optical effect, and wherein the actively shuttered viewing devices each comprises left and right viewing ports with complimentary optical filters so as to produce a three dimensional effect in each of the first and second video streams.

8. The method of claim 1, further comprising:
transmitting a first audio stream to the first actively shuttered viewing device, the first audio stream corresponding to the first video stream; and
transmitting a second audio stream to the second actively shuttered viewing device, the second audio stream corresponding to the second video stream;
wherein the first and second audio streams each played by the first and second actively shuttered viewing devices, respectively, such that the user of the first actively shuttered device can hear the first audio stream and the user of the second actively shuttered device can hear the second audio stream.

9. A video display system, comprising:
a monitor operable to graphically render video frames;
a rendering engine operable to render frames of a first video stream and a second video stream on the monitor in alternating fashion, and provide a sync signal that changes state in correspondence with the alternating;
wherein the sync signal is provided to a first actively shuttered viewing device and a second actively shuttered viewing device, the first actively shuttered viewing device uses the sync signal to allow a first viewer using the first actively shuttered viewing device to see the first video stream but not the second video stream, the second actively shuttered viewing device uses the sync signal to allow a second viewer using the second actively shuttered viewing device to see the second video stream but not the first video stream.

10. The video display system of claim 9, further comprising:
a camera operable to determine a location of each of the first and second actively shuttered viewing devices relative to the monitor based on optical markers on each of the first and second actively shuttered viewing devices;
wherein the first and second video streams are generated in correspondence with the locations of the first and second actively shuttered viewing devices to provide a virtual three dimensional effect to the first and second video streams.

11. The video display system of claim 9, further comprising a game console, wherein the first and second video streams present first and second game views, respectively, for a game played on the game console.

12. The video display system of claim 11, wherein the game console includes first and second game controllers, the first actively shuttered viewing device is associated with the first game controller and the second actively shuttered viewing device is associated with the second game controller, each of the first and second actively shuttered viewing devices utilize their respective associations to the first and second game controllers to time shuttering with the sync signal to first and second video streams, respectively.

13. The video display system of claim 9, wherein the sync signal is transmitted to the first and second actively shuttered viewing devices via wireless links.

14. The video display system of claim 9, wherein each of the first and second video streams contain left and right divisions, and wherein the first and second actively shuttered viewing devices alternately open and close a left lens and a right lens in correspondence with the left and right divisions to provide a three dimensional effect.

15. The video display system of claim 9, wherein the first and second video streams are rendered with a three dimensional effect in each frame, the first and second actively shuttered viewing devices each have a left and right lens having complimentary optical filters for filtering the three dimensional effect such that the first and second video streams can be viewed in apparent three dimensions by users of the first and second actively shuttered viewing devices.

16. The video display system of claim 9, wherein each of the first and second video streams have an associated audio stream, each of the first and second actively shuttered viewing devices comprise one or more speakers for playing the associated audio stream.

17. A method for displaying video for two players of an interactive video game, comprising:
generating a first video stream of a first game view for a first player using a first actively shuttered viewing device;
generating a second video stream of a second game view for a second player using a second actively shuttered viewing device;
alternately rendering frames of the first and second video streams on a monitor viewed by the first and second players through the first and second actively shuttered viewing devices, respectively;
generating a sync signal that alternately changes state in correspondence with rending the frames; and
transmitting the sync signal to each of the first and second actively shuttered viewing devices;
wherein the first and second actively shuttered viewing devices utilize the sync signal to control shuttering such that the first player can see the first video stream but not the second video stream and the second player can see the second video stream but not the first video stream.

18. The method of claim 17, further comprising associating the first and second actively shuttered viewing devices with first and second game controllers, respectively, and wherein the association is used in conjunction with the sync signal to time shuttering by each of the first and second actively shuttered viewing devices.

19. The method of claim 17, further comprising transmitting audio signals associated with the first and second video streams to the first and second actively shuttered viewing devices, respectively.

20. The method of claim 17, wherein transmitting the sync signal comprises wirelessly transmitting the sync signal.

21. A method for presenting multiple video streams on a monitor to be viewed exclusive of each other by different viewers, comprising:
rendering a first video stream on the monitor using a first optical effect such that a first viewer using a first viewing device having left and right lenses both optically configured in correspondence with the first optical effect can see the first video stream;
while rendering the first video stream on the monitor, rendering a second video stream on the monitor using a second optical effect such that a second viewer using a second viewing device having left and right lenses both optically configured in correspondence with the second optical effect can see the second video stream;
wherein the first and second optical effects are complimentary such that the second video stream is substantially suppressed optically by the first viewing device, and the first video stream is substantially suppressed optically by the second viewing device.

22. The method of claim 21, wherein the first optical effect comprises a first optical polarization, the second optical effect comprises a second optical polarization, and wherein the first and second polarizations are orthogonal to each other.

23. The method of claim 21, wherein the first optical effect comprises a first colorization of the first video stream, the second optical effect comprises a second colorization of the second video stream, and wherein the first and second colorizations are optically complimentary.

24. The method of claim 21, wherein the first and second video streams are first and second game video streams, respectively, of an interactive multiplayer video game.

25. The method of claim 21, wherein the first and second video streams are each further rendered with a virtual reality effect based on an angle of view of each of the first and second viewing devices, respectively.

26. The method of claim 21, wherein each of the first and second viewing devices are actively shuttered viewing devices, rendering the first and second video streams comprises alternately rendering left and right frames in synchronization with shuttering the first and second actively shuttered viewing devices to provide a three dimensional effect for each of the first and second video streams.

27. The method of claim 21, wherein the rendering the first and second video streams further comprises rendering the first video stream from a first source, and rendering the second video stream from a second source, wherein the first and second sources are unrelated to each other.

28. A video presentation system for displaying multiple exclusively viewable video streams on a single monitor, comprising:
a first optical effect processor that applies a first optical effect to a first video stream, wherein the first optical effect is such that a first viewer using a first viewing device having left and right lenses both optically configured in correspondence with the first optical effect can see the first video stream;
a second optical effect processor that applies a second optical effect to a second video stream, wherein the second optical effect is such that a second viewer using a second viewing device having left and right lenses both optically configured in correspondence with the second optical effect can see the second video stream;
a stream combiner that combines the first and second video streams including the first and second optical effects into a composite signal; and
a rendering engine that visually renders the composite signal on the monitor including the first and second optical effects;
wherein the first and second optical effect are complimentary such that the second video stream is substantially suppressed optically by the first viewing device, and the first video stream is substantially suppressed optically by the second viewing device.

29. The video presentation system of claim 28, wherein the first and second optical effects are first and second orthogonal optical polarizations.

30. The video presentation system of claim 28, wherein the first and second optical effects are complimentary colorizations.

31. The video presentation system of claim 28, wherein the first and second video streams are first and second game video streams, respectively, of an interactive multiplayer video game.

32. The video presentation system of claim 28, wherein each of the first and second viewing devices are actively shuttered viewing devices, the first and second video streams each comprise left and right frames that are rendered in synchronization with shuttering the first and second actively shuttered viewing devices to provide a three dimensional effect for each of the first and second video streams.
